(19) United States
(12) Patent Application Publication
(10) Pub. No.: US 2013/0134761 A1
(43) Pub. Date: May 30, 2013

(54) ADJUSTABLE HEAD RESTRAINT ASSEMBLY FOR VEHICLE SEATS

(71) Applicants: Scott Andrew Willard, Rochester, MI (US); Arjun Yetukuri, Rochester Hills, MI (US); Gerald Steven Locke, Lake Orion, MI (US)

(72) Inventors: Scott Andrew Willard, Rochester, MI (US); Arjun Yetukuri, Rochester Hills, MI (US); Gerald Steven Locke, Lake Orion, MI (US)

(73) Assignee: LEAR CORPORATION, Southfield, MI (US)

(21) Appl. No.: 13/304,920

(22) Filed: Nov. 28, 2011

(51) Int. Cl. B60N 2/48

(52) U.S. Cl. 297/408

(57) ABSTRACT

An adjustable vehicle head restraint assembly is provided with a post mounted in a vehicle proximate to a seat back. A transverse shaft is mounted to the post. A head restraint is pivotally connected to the transverse shaft. An actuator is mounted to the head restraint. A striker is mounted to one of the transverse shaft and the head restraint. A latch is mounted to the other of the transverse shaft and the head restraint in engagement with the striker, such that actuation of the actuator in the transverse direction disengages the latch from the striker for rotation of the head restraint relative to the transverse shaft. Rotation of the head restraint from a collapsed position to an upright position causes the latch to engage the striker, which retracts the latch until the head restraint reaches the upright position, and the latch extends thereby locking the head restraint.

### TECHNICAL FIELD

Various embodiments relate to adjustable vehicle head restraint assemblies.

### BACKGROUND

Vehicle seats are often provided with movable head restraints, which can move to accommodate a head of an occupant and/or can move to various stowed positions to provide a compact seat in a stowed position.

### BRIEF DESCRIPTION OF THE DRAWINGS

FIG. 1 is a partially disassembled perspective view of an adjustable vehicle head restraint assembly according to an embodiment and illustrated in an upright position;

FIG. 2 is another perspective view of the head restraint assembly of FIG. 1, illustrated in a collapsed position;

FIG. 3 is a further disassembled perspective view of the adjustable vehicle head restraint assembly of FIG. 1, illustrating a latch mechanism;

FIG. 4 is an enlarged perspective view of the latch mechanism of the adjustable head restraint assembly of FIG. 3;

FIG. 5 is a further enlarged perspective view of the latch mechanism of FIG. 3;

FIG. 6 is a partially disassembled perspective view of the adjustable vehicle head restraint assembly of FIG. 1, illustrated in the collapsed position;

FIG. 7 is an enlarged side perspective view of a button assembly of the vehicle head restraint assembly of FIG. 1; and

FIG. 8 is another enlarged side perspective of the button assembly of FIG. 7.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

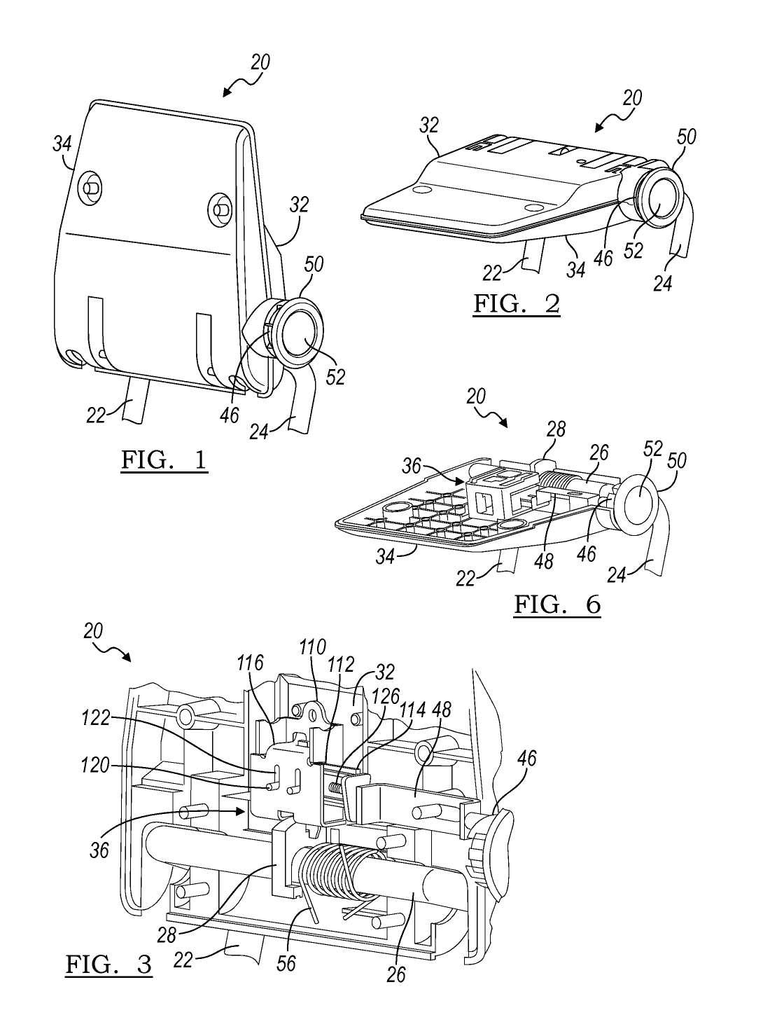

With reference now to FIGS. 1 and 2, an adjustable vehicle head restraint assembly is illustrated and referenced generally by numeral 20. The head restraint assembly 20 may be mounted in a vehicle proximate to a seat back for use in the vehicle, such as an automobile, a boat or an airplane. The head restraint assembly 20 may be mounted directly to the vehicle seat back, or may be mounted to the vehicle body. The head restraint assembly 20 may be utilized with any style seat, such as a first row seat, a second row seat, a third row seat, or the like. Likewise, the head restraint assembly 20 may be employed with a sports car seat, a single passenger seat, a captain's chair, a bench seat, or the like.

The head restraint assembly 20 has a pair of posts 22, 24 for mounting the head restraint assembly 20 to a vehicle seat back, as is known in the art. The posts 22, 24 can be formed separately or may be formed integrally with a cross-bar connecting the posts. For the depicted embodiment, the posts 22, 24 are formed integrally. Although the posts 22, 24 are for mounting to a vehicle seat back, the invention contemplates that the posts 22, 24 may be utilized for mounting at any location on a vehicle body for orienting the head restraint assembly 20 proximate to the vehicle seat back for supporting a head of an occupant.

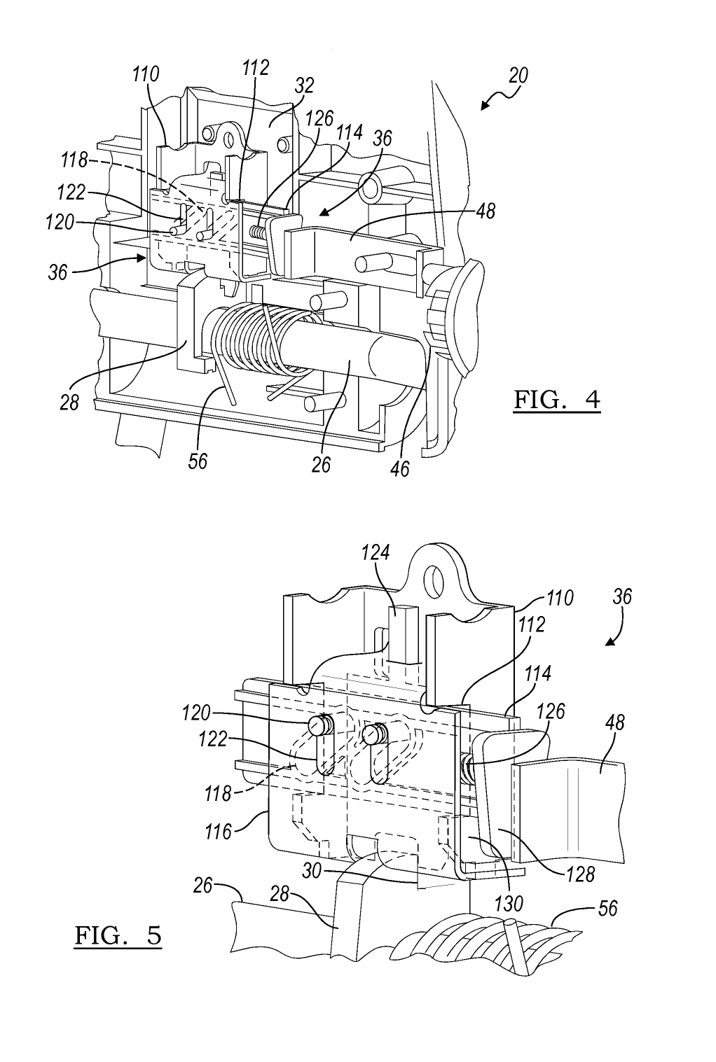

Referring now to FIGS. 3 through 6, in at least one embodiment, the proximal ends of the posts 22, 24 are interconnected by a crossbar or transverse shaft 26. A striker 28 is mounted to the transverse shaft 26. The striker 28 is fixed to the shaft 26 by welding or any suitable fastener. The striker 28 has a radial recess 30 for providing a locking position corresponding to an upright position of the head restraint assembly 20.

Referring again to FIGS. 1 and 2, the head restraint assembly 20 includes a rear shell 32 and a front shell 34 for collectively providing the underlying structure for the head restraint assembly 20. The rear and front shells 32, 34 are provided in a two-piece arrangement which enclose the components of the head restraint assembly 20 once assembled and collectively provide a pivotal connection upon the transverse shaft 26.

With reference again to FIGS. 3 through 6, the head restraint assembly 20 includes a latch mechanism 36 for latching the head restraint and the shells 32, 34 at the upright position (FIGS. 1, 3, 4 and 5) relative to the transverse shaft 26.

In FIGS. 1-4 and 6, a bushing or sleeve 46 is mounted to the shells 32, 34 for actuation of a push rod 48 that is mounted for translation upon the rear shell 32. A bezel 50 is mounted to the bushing 46 on the exterior of the head restraint assembly 20. In other words, foam padding, cushioning, trim material and the like are provided about and supported upon the shells 32, 34. The bezel 50 is provided external of these components for covering an aperture provided through these components. A push button 52 extends from the bezel 50 for manual actuation of the push rod 48. The push rod 48 engages the latch mechanism 36 so that manual actuation of the push button 52 extends the push rod 48 laterally inward relative to the head restraint assembly 20 thereby unlatching the latch mechanism 36.

A torsion spring 56 is provided on the transverse shaft 26 in engagement with the rear shell 32 for urging the head restraint shells 32, 34 to pivot to a forward-most position when the latch mechanism 36 is disengaged from the striker 28, thereby collapsing or folding the head restraint assembly 20.

The head restraint assembly 20 permits an occupant to fold the head restraint assembly 20 with a one-handed operation. The occupant unlocks the head restraint assembly 20 by pressing the button 52, and the torsion spring 56 pivots the head restraint assembly 20 forward until the head restraint assembly 20 reaches a forward-most position.

The head restraint assembly 20 provides pivotal adjustment of the head restraint and shells 32, 34 relative to the transverse shaft 26 for collapsing the head restraint assembly 20. The latch mechanism 36 employed permits a relatively compact head restraint assembly 20. The torsion spring 56 urges the head restraint and shells 32, 34 to a forward-most position to collapse the head restraint assembly 20.

A guide bracket 110 is mounted to the rear shell 32 and has a cut-out 112 formed therein for receiving a transverse slider 114 as illustrated in FIGS. 3-6. A retainer plate 116 is mounted to the guide bracket 110 to retain the transverse slider 114 within the cut-out 112. The transverse slider 114 includes a pair of angled slots 118, each of which receives a follower, such as a pin 120 therethrough. The pins 120 are also received in longitudinal slots 122 in the retainer plate 116 in the guide bracket 112 for moving up and down within the longitudinal slots 122 as actuated by the angled slots 118 of the transverse slider 114 when the transverse slider 114 is translated. A longitudinal slider 124 is mounted to the pins 120 for being translated towards and away from the transverse shaft 26 dependent upon the position of the transverse slider 114. The longitudinal slider 124 is received within the recess 30 of the striker 28.

Depression of the push button 52 actuates the push rod 48 to move the transverse slider 114 transversely. The angled slots 118 drive the pins 120 upward within the longitudinal slots 122 as depicted in FIG. 5, thereby converting the linear motion in a transverse direction to linear motion in a longitudinal direction. As the pins 120 are translated upward, the longitudinal slider 124 is retracted from the recess 30 of the striker 28 as illustrated in FIG. 5, thereby permitting pivotal adjustment of the head restraint assembly 28 and shells 32, 34 relative to the transverse shaft 26 to the collapsed position of FIGS. 2 and 6. By orienting the operational components with the latch engagement component, namely the longitudinal slider 124, in an upright direction of the head restraint 20, an overall thickness of the head restraint assembly 20 is minimized at, for example, thirty-six millimeters.

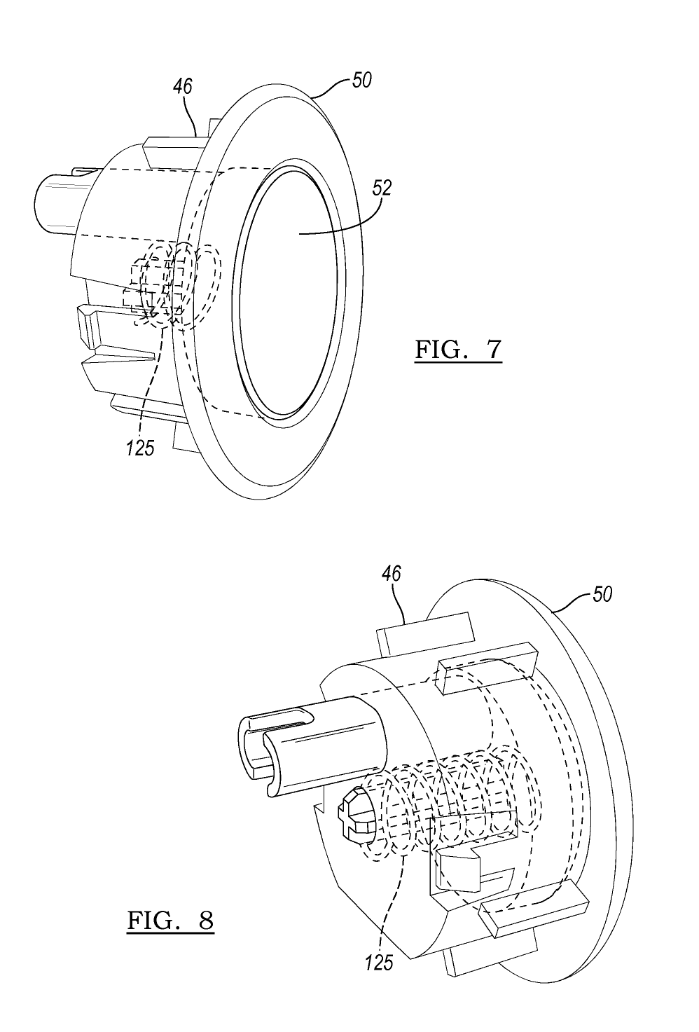

Referring now to FIGS. 7 and 8, release of the manual button 52 results in return of the manual button 52 to a locked position due to a compression spring 125 oriented between the manual button 52 and the bushing 46. With reference again to FIG. 5, a compression spring 126 is provided between a tab 128 on an end of the transverse slider 114 and a sidewall 130 of the retainer plate 116. When a manual force is released from the manual button 52, the transverse slider 114 is returned to a locked position by the compression spring 126 wherein the longitudinal slider 124 engages the recess 30 of the striker 28, when the head restraint 20 is in the upright position. The push rod 48 is returned to the unloaded position by the compression spring 126 thereby returning the push button 52 to the locked position. When the manual button 52 is released and the head restraint 20 is not in the upright position, such as the collapsed position, the longitudinal slider 124 is not engaged in the recess 30 of the striker 28. As the head restraint assembly 20 is pivoted towards the upright position, the longitudinal slider 124 engages the striker 28 thereby retracting the longitudinal slider 124. As the head restraint assembly 20 is further pivoted, the longitudinal slider 124 aligns with the recess 30 in the striker 28, and extends into the recess 30 due to the return force of the compression spring 126, which locks the head restraint assembly 20 in the upright position.

The above-depicted head restraint assembly provides a compact head restraint assembly 20 that is adjustable to the collapsed position. The head restraint assembly 20 employs many common components with the tilt adjustable head restraint assemblies disclosed in U.S. patent application Ser. No. 12/884,895, filed on Sep. 17, 2010, which is incorporated in its entirety by reference herein.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An adjustable vehicle head restraint assembly comprising:
at least one post adapted to be mounted in a vehicle proximate to a seat back;
a transverse shaft mounted to the at least one post;
a head restraint pivotally connected to the transverse shaft;
an actuator mounted to the head restraint;
a striker mounted to one of the transverse shaft and the head restraint; and
a latch mounted to the other of the transverse shaft and the head restraint in engagement with the striker, such that actuation of the actuator in a transverse direction disengages the latch from the striker for permitting rotation of the head restraint relative to the transverse shaft, wherein rotation of the head restraint from a collapsed position to an upright position while the actuator is not actuated causes the latch to engage the striker thereby retracting the latch until the head restraint reaches the upright position and the latch extends thereby locking the head restraint.

2. The head restraint assembly of claim 1 wherein the striker is affixed to the transverse shaft;
wherein the latch is mounted to the head restraint for translation; and
wherein the head restraint assembly further comprises a biasing member cooperating with the latch for maintaining the latch in a locked position.

3. The head restraint assembly of claim 2 wherein the latch is mounted to the head restraint to translate in a direction that is not parallel to the translation of the actuator.

4. The head restraint assembly of claim 2 wherein the latch is mounted to the head restraint for translation in a direction that is perpendicular to the translation of the actuator thereby resulting in enhanced compactness of the head restraint assembly.

5. The head restraint assembly of claim 2 wherein the biasing member comprises a compression spring.

6. The head restraint assembly of claim 1 wherein the latch is mounted to the head restraint for translation in a direction perpendicular to the actuator;
wherein the striker is affixed to the transverse shaft; and
wherein the head restraint assembly further comprises a biasing member cooperating with the latch to maintain the latch in a locked position.

7. The head restraint assembly of claim 6 wherein the biasing member further comprises a compression spring.

8. The head restraint assembly of claim 1 further comprising a biasing member cooperating with the transverse shaft and the head restraint to urge the head restraint to a forward-most position in response to actuation of the actuator.

9. The head restraint assembly of claim 8 wherein the biasing member comprises a torsion spring.

10. An adjustable vehicle head restraint assembly comprising:
at least one post adapted to be mounted in a vehicle proximate to a seat back;
a transverse shaft mounted to the at least one post;
a head restraint pivotally connected to the transverse shaft;
a striker provided on the transverse shaft;
a latch mechanism mounted to the head restraint for translation in a transverse direction for engagement with the striker; and
an actuator mounted to the head restraint in cooperation with the latch mechanism such that actuation of the actuator in a transverse direction disengages the latch mechanism from the striker for permitting rotation of the head restraint relative to the transverse shaft, wherein rotation of the head restraint from a collapsed position to an upright position while the actuator is not actuated causes the latch to engage the striker thereby retracting the latch until the head restraint reaches the upright position and the latch extends thereby locking the head restraint.

11. The head restraint assembly of claim 10 wherein the latch mechanism comprises:
a first slider mounted to the head restraint for translation in the transverse direction, the first slider being in cooperation with the actuator; and
a second slider mounted to the head restraint for translation in a direction generally perpendicular to the transverse direction, the second slider being in cooperation with the first slider such that translation of the first slider actuates the second slider to retract and extend the second slider in order to engage and disengage the second slider with the striker.

12. The head restraint assembly of claim 11 further comprising a biasing member in cooperation with the first slider for maintaining the first slider, and consequently the second slider, in a locked position.

13. The head restraint assembly of claim 12 wherein the biasing member comprises a compression spring.

14. The head restraint assembly of claim 11 wherein the first slider has one portion of an angled slot formed therein and a follower extending therefrom;
wherein the second slider has the other portion of the angled slot formed therein and the follower extending therefrom; and
wherein the follower is received in the angled slot to convert translation of the first slider to translation of the second slider.

15. The head restraint assembly of claim 10 further comprising a biasing member cooperating with the transverse shaft and the head restraint to urge the head restraint to a forward-most position in response to actuation of the actuator.

16. The head restraint assembly of claim 15 wherein the biasing member comprises a torsion spring.

17. The head restraint of claim 10 wherein the striker extends radially from the transverse shaft; and
wherein the latch mechanism converts translation in the transverse direction to translation in a perpendicular direction.

18. An adjustable vehicle head restraint assembly comprising:
at least one post adapted to be mounted in a vehicle proximate to a seat back;
a transverse shaft mounted to the at least one post;
a head restraint pivotally connected to the transverse shaft;
a striker provided on the transverse shaft extending radially toward the head restraint;
a latch mechanism mounted to the head restraint for converting translation in a transverse direction to translation in a direction perpendicular to the transverse direction for engagement with the striker; and
an actuator mounted to the head restraint in cooperation with the latch mechanism such that actuation of the actuator in a transverse direction disengages the latch mechanism from the striker for permitting rotation of the head restraint relative to the transverse shaft, wherein rotation of the head restraint from a collapsed position to an upright position while the actuator is not actuated causes the latch to engage the striker thereby retracting the latch until the head restraint reaches the upright position and the latch extends thereby locking the head restraint.

19. The head restraint assembly of claim 18 wherein the latch mechanism comprises:
a first slider mounted to the head restraint for translation in the transverse direction, the first slider being in cooperation with the actuator; and
a second slider mounted to the head restraint for translation in a direction generally perpendicular to the transverse direction, the second slider being in cooperation with the first slider such that translation of the first slider actuates the second slider to retract and extend the second slider to disengage and engage the second slider with the striker.

20. The head restraint assembly of claim 19 wherein the first slider has one portion of an angled slot formed therein and a follower extending therefrom;
wherein the second slider has the other portion of the angled slot formed therein and the follower extending therefrom; and
wherein the follower is received in the angled slot to convert translation of the first slider to translation of the second slider.
